(19) United States
(12) Patent Application Publication
(10) Pub. No.: US 2024/0261988 A1
(43) Pub. Date: Aug. 8, 2024

(54) KARAMBIT STRUCTURE

(71) Applicant: QIANG ZHOU, Plano, TX (US)

(72) Inventor: QIANG ZHOU, Plano, TX (US)

(21) Appl. No.: 18/436,005

(22) Filed: Feb. 7, 2024

(30) Foreign Application Priority Data
Feb. 8, 2023 (CN) 202320237516.2

(51) Int. Cl. B26B 1/02; B26B 1/10

(52) U.S. Cl. CPC B26B 1/02; B26B 1/10

(57) ABSTRACT

A Karambit with a three-fold structure comprises a main handle, an auxiliary handle, and a blade. The blade is curved with a sharp front end and a concave cutting side. There is a finger ring at a rear end of the main handle. The main handle is pivotally connected to one end of the auxiliary handle via a first pin at a rear upper part of the main handle. The auxiliary handle is pivotally connected to a tail end of the blade via a second pin at the other end of the auxiliary handle. There is a longitudinal groove on an upper side of the main handle. In a fully folded state, at least a portion of the auxiliary handle and the blade are in the longitudinal groove, and the front end of the blade is located behind the first pin, thereby allowing the blade to be longer.

### FIELD OF INVENTION

The present disclosure relates to a knife structure, specifically to a novel Karambit structure.

### BACKGROUND

Karambit is a type of knife popular in Indonesia and Malaya. FIG. 1 shows a typical structure of this type of knife, characterized by a concave cutting side of the blade and a finger ring at the end of the handle, which is inserted by a finger when holding the handle. This type of knife is not only suitable for self-defense, but can also be used for some daily work.

In addition to the integrated structure of the blade and handle shown in FIG. 1, this type of knife has also been developed into a folding structure in modern times, that is, the blade can be folded and stored in the handle, as shown in FIG. 2. However, one drawback of this folding knife is that the blade is too short. This is because, for the sake of portability, the handle cannot be too long, and the finger ring cannot be grooveted for the blade to be hidden since the finger ring shall be inserted with a finger of the user when the user is unfolding the blade from the handle groove or folding the blade into the the handle groove. If the groove is also made at the finger ring, the cutting side of the blade will hurt the finger.

Therefore, a drawback of the existing Karambit is that the blade is too short to meet usage requirements.

### SUMMARY

This utility model proposes a novel structure of Karambit, which can extend the blade to the maximum capacity of the handle.

The Karambit structure of this disclosure is a three-fold structure, including a main handle, an auxiliary handle, and a blade. The blade is curved with a sharp front end and a concave cutting side. There is a finger ring at the rear end of the main handle. At the rear upper part of the main handle, there is a first pin that runs through the main handle, and the main handle is pivotally connected to one end of the auxiliary handle via the first pin. At the other end of the auxiliary handle, there is a second pin that runs through the auxiliary handle, and the auxiliary handle is pivotally connected to the tail end of the blade via the second pin. There is a longitudinal groove on the upper side of the main handle. When the Karambit is in a fully folded state, at least a portion of the auxiliary handle and the blade are in the longitudinal groove of the main handle, and the front end of the blade is located behind the first pin by utilizing the concave feature of the cutting side of the blade. Therefore, it is allowed to make the blade longer.

### BRIEF DESCRIPTION OF THE DRAWINGS

The accompanying drawings show the prior art and exemplary embodiments of the present disclosure only for illustrative purposes, in which:

FIG. 1 shows a Karambit structure that integrates the blade and handle in the prior art;

FIG. 2 shows another Karambit structure that is foldable in the prior art;

FIG. 3 is a diagram of a Karambit structure which is in an unfolded state according to the present disclosure;

FIG. 4 is a diagram of the Karambit structure in which a blade and an auxiliary handle are folded according to the present disclosure;

FIG. 5 is a diagram of the Karambit structure which is in fully folded state according to the present disclosure;

FIG. 6 is a diagram of the Karambit structure in usage state according to the present disclosure;

FIG. 7 is an exploded view of a specific implementation of the Karambit structure according to the present disclosure.

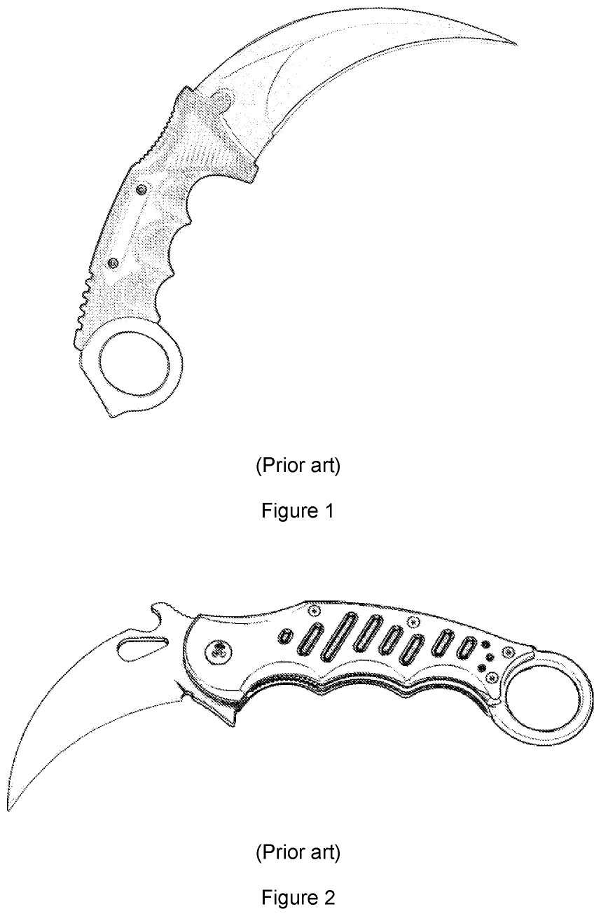

### DETAILED DESCRIPTION

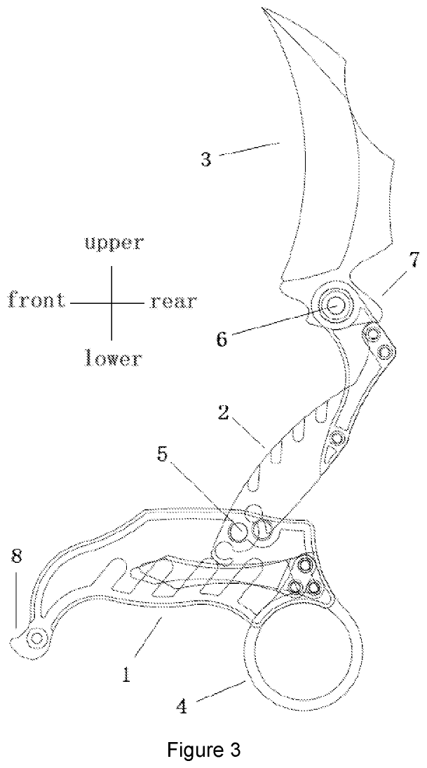

FIG. 3 is a diagram of a Karambit structure which is in an unfolded state according to the present disclosure. The Karambit structure of this disclosure is a three-fold structure, including a main handle 1, an auxiliary handle 2, and a blade 3. The blade 3 is curved with a sharp front end and a concave cutting side. For the convenience of description, the directional words “upper, lower, front, and rear” mentioned in the present disclosure all refer to the directions shown in FIG. 3. There is a finger ring 4 at the rear end of the main handle 1. In use, the user usually inserts his index or little finger into the ring 4. Therefore, for ease of grip, the ring 4 is usually positioned at the lower side of the rear end of the main handle 1. There is a longitudinal groove on the upper side of the main handle 1. At the rear upper part of the main handle 1, there is a first pin 5 that runs through the main handle 1. The main handle 1 is pivotally connected to one end of the auxiliary handle 2 through the first pin 5. At the other end of the auxiliary handle 2, there is a second pin 6 that runs through the auxiliary handle 2. The auxiliary handle 2 is pivotally connected to the tail end of the blade 3 through the second pin 6.

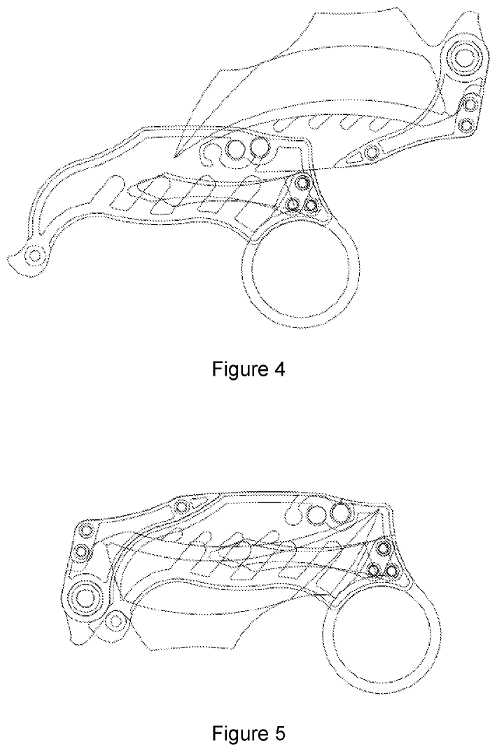

In the state shown in FIG. 3, when the blade 3 rotates about the second pin 6 to overlap with the auxiliary handle 2, as shown in FIG. 4, and then the auxiliary handle 2 and the blade 3 as a whole rotate about the first pin 5 to overlap with the main handle 1, that is, the Karambit is in a folded state, as shown in FIG. 5, at least a part of the auxiliary handle 2 and the blade 3 are in the longitudinal groove of the main handle 1. By utilizing the characteristic of the concave cutting side of the blade of the Karambit, the front end of the blade 3 can be located behind the first pin 5 in the folded state, without affecting the unfolding and folding of the auxiliary handle 2. Therefore, it is allowed to make the blade 3 longer.

As shown in FIG. 3, when the blade 3 unfolds about the second pin 6 to a certain angle, a rear end protrusion 7 of the blade 3 abuts against the end of the auxiliary handle 2, thereby limiting the excessive unfolding of the blade 3. Therefore, according to the needs, by appropriately designing the rear end protrusion 7, the unfolding angle of the blade 3 can be defined.

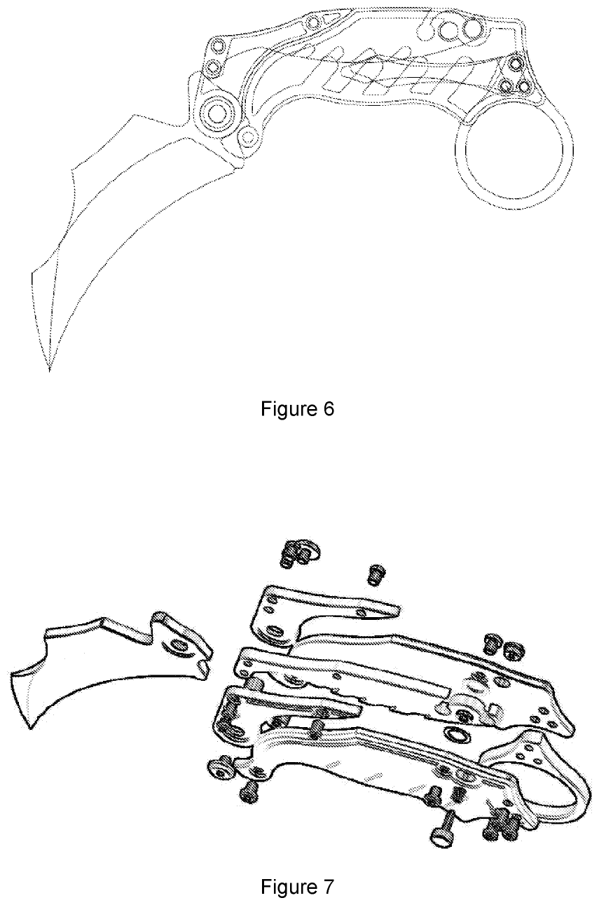

Under the state shown in FIG. 3 in which the blade 3 is unfolded relative to the auxiliary handle 2, when the auxiliary handle 2 rotates forward about the first pin 5 until it overlaps with the main handle 1, as shown in FIG. 6, the front end protrusion 8 of the main handle 1 (see FIG. 3) abuts against the rear lower end of the blade 3, so the blade 3 cannot rotate in both directions. At this point, the Karambit is in use state.

FIG. 7 is an exploded view of an actual designed Karambit structure using the principles of the present disclosure. The main handle is composed of two parts, fixed together by screws, and the longitudinal groove of the main handle is formed by means of a separator composed of a finger ring and pins. FIG. 7 is only a specific implementation of the present disclosure, and those skilled in the art may come up with other designs after reading the present disclosure. By adopting this three-fold structure, compared to existing foldable Karambits, the blade can be extended by about 1 centimeter. For Karambits, this is a significant improvement and can have greater practicality.

What is claimed is:

1. A structure of a Karambit, characterized in that the structure of the Karambit is a three-fold structure, including a main handle, an auxiliary handle, and a blade, the blade being curved with a sharp front end and a concave cutting side, at a rear end of the main handle, there is a finger ring, and at an upper rear part of the main handle, there is a first pin that runs through the main handle, the main handle is pivotally connected to one end of the auxiliary handle via the first pin, and at the other end of the auxiliary handle, there is a second pin that runs through the auxiliary handle, the auxiliary handle is pivotally connected to a tail end of the blade via a second pin, there is a longitudinal groove on an upper side of the main handle, and when the Karambit is in a fully folded state, at least a portion of the auxiliary handle and the blade are in the longitudinal groove of the main handle, and the front end of the blade is located behind the first pin.
